(19) United States
(12) Patent Application Publication
(10) Pub. No.: US 2003/0094806 A1
(43) Pub. Date: May 22, 2003

(54) Vinyl lace and bead bound foam-based book and method of making

(76) Inventor: William Derraugh, Weston, CT (US)

Correspondence Address: Tope-McKay & Associates, 23852 Pacific Coast Highway #311, Malibu, CA, 90265, US

(21) Appl. No.: 09/996,463

(22) Filed: Nov. 20, 2001

(51) Int. Cl. B42D 1/00

(52) U.S. Cl. 281/21.1

(57) ABSTRACT

A vinyl lace and bead bound foam-based book is presented herein. The foam book includes a plurality of soft pages made from a foam material stacked together to form a book. The foam pages if the book are perforated with at least one hole therethrough, with a vinyl lace and bead binding retaining the pages at each hole with the vinyl strip of the binding passed through the hole in the pages and the hole in the bead. The vinyl strip is knotted in such a way that the bead and the pages are held by the vinyl strip, whereby the pages may be held in a book-like fashion with the vinyl strip forming a loop-type binding.

### BACKGROUND OF THE INVENTION

1. Field of the Invention

The present invention relates to bookbinding, and more specifically relates to a vinyl string knotted at the ends which holds a bead; thus forming a ring binding for a book. This type of binding is particularly useful for foam books as it is water-resistant and can be suitable for reading in the bath.

2. Description of the Prior Art

Bookbinding has been a useful art for many centuries. In more recent times, bookbinding became even more widespread with the advent of printing machines. There are numerous references both in the literature and in the patent archives detailing various bookbinding techniques. In a broad sense, binding techniques have been applied to create books as well as to simply retain loose leaf papers and other materials.

More recently, written pages have been adapted for varying purposes, and a wide variety of materials have been used in their creation. Traditionally, children's books have hard or semi-hard covers and large type of sheets of paper. While these books are suitable for children of preschool age, they are not adequate for younger children. Younger children tend to learn about their world through their tactile senses. A great alternative to the traditional books with sharp edges are soft non-paper books with which younger children can physically play with. In addition to the soft, non-paper characteristics, it is desirable to have a book made from a material that is water resistant, so a child can read it and play with it while in the bath or by the pool side. One of the materials particularly suitable for this purpose is foam.

Numerous ring binders for use in binding books and loose papers have been provided in the patent literature, a few examples of which include U.S. Pat. Nos. 6,113,298; 5,692,848; 4,545,603; 4,120,517. Several of these ring bindings are used to hold loose-leaf pages in a book or a binder. However, they are generally designed for use with wood-based paper materials and not with foam-based materials. While the mentioned devices fulfill the particular purpose they address, they are generally metal-based and rigid in their construction. Because of their metallic nature, they generally are not suited for use around water. Additionally, their rigid structures make them apt to cause injuries when played with by small children. It is therefore desirable to provide a non-metallic, non-rigid binding for use with foam children's books. It is particularly desirable that the binding be designed for use in and around water, and in such a manner as to be safe to play with. Finally, it is desirable that the binding be sufficiently soft so as not to destroy the pages of a foam book.

### SUMMARY OF THE INVENTION

The present invention provides a vinyl lace and bead bound foam-based book. The book comprises at least one vinyl lace and bead binding including a vinyl strip and a bead having at least one hole. A plurality of foam pages is perforated with at least one hole there through where vinyl lace and bead binding retain the pages at each hole. The vinyl strip of the binding passed through the hole in the pages is then passed through the hole in the bead. The vinyl strip is connected with the bead such that the bead and the pages are held by the vinyl strip. Thus, the pages may be held in a book-like fashion with the vinyl strip forming a loop-type binding.

The vinyl strip is generally connected with the bead by passing the vinyl strip through a hole in the bead and tying the vinyl strip such that the bead is retained thereon. The vinyl strip can be detachably connected with the bead, so that the vinyl and lace bead binding may be removed and the pages separated. In this embodiment, it is possible for the vinyl and lace bead binding to be sizably adjusted to accommodate a variable number of pages. Further, in order to entertain children, the beads may be in the shape of an animal and may include a noise-making device.

The present invention also comprises a method for binding a foam-based book using a vinyl lace and bead binder. The method comprises a first step of providing at least one vinyl lace and bead binding including a vinyl strip and a bead having at least one hole. Next, a plurality of foam pages are provided, the foam pages being perforated with at least one hole therethrough. The pages are then retained with a vinyl lace and bead binding by passing the vinyl strip of the binding through the hole in the pages and the hole in the bead. Finally, the vinyl strip is connected so that the bead and the pages are held by the vinyl strip. Thus, the pages may be held in a book-like fashion with the vinyl strip forming a loop-type binding.

In a further embodiment, in the step of connecting the vinyl strip, the vinyl strip may be tied such that the bead and the pages are held by the vinyl strip. The step of connecting the vinyl strip may also comprise detachably attaching the vinyl strip to the bead such that the bead and the pages are held by the vinyl strip. Further, the step of connecting the vinyl strip may comprise a sub-step of sizably adjusting the vinyl lace and bead binding to accommodate a varying number of pages. The vinyl strip may also be connected to the bead by tying the vinyl strip.

To enhance the bead's attractiveness to children, the bead may be provided in the shape of an animal and may include a noise-making device.

### BRIEF DESCRIPTION OF THE DRAWINGS

The novel features of the present invention are set forth in the appended claims. In order to better show the characteristics of the invention, some preferred embodiments are described hereafter, as examples without any limitative character. The features, aspects, and advantages of the present invention may be best understood in conjunction with the detailed description, with reference to the accompanying drawings where:

FIG. 1(a) is an illustration of a vinyl lace and bead used for binding a plurality of foam pages to create the bound foam book of the present invention;

FIG. 1(b) is a perspective view of a foam book bound by the vinyl lace and bead binding mechanism of the present invention;

FIG. 2(a) is an illustration of a vinyl lace and bead used for binding a plurality of foam pages depicted with the lace passed through the bead and knotted in a manner which would secure a plurality of foam pages;

FIG. 2(b) is an illustration of a vinyl lace and bead used for binding a plurality of foam pages depicted with the lace passed through the bead and fixedly secured to itself in a manner which would secure a plurality of foam pages;

FIG. 2(c) is an illustration of a vinyl lace and bead used for binding a plurality of foam pages depicted with the lace passed through the bead and fixedly secured by a spring-loaded retention mechanism that can be used to adjust the length of the lace used for securing a plurality of foam pages; and

FIG. 3 is a perspective view of an alternate embodiment of the present invention, wherein a vinyl lace is threaded through a plurality of holes in a plurality of foam pages and secured by a single bead.

### DETAILED DESCRIPTION OF THE PREFERRED EMBODIMENTS

The present invention relates to the field bookbinding. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

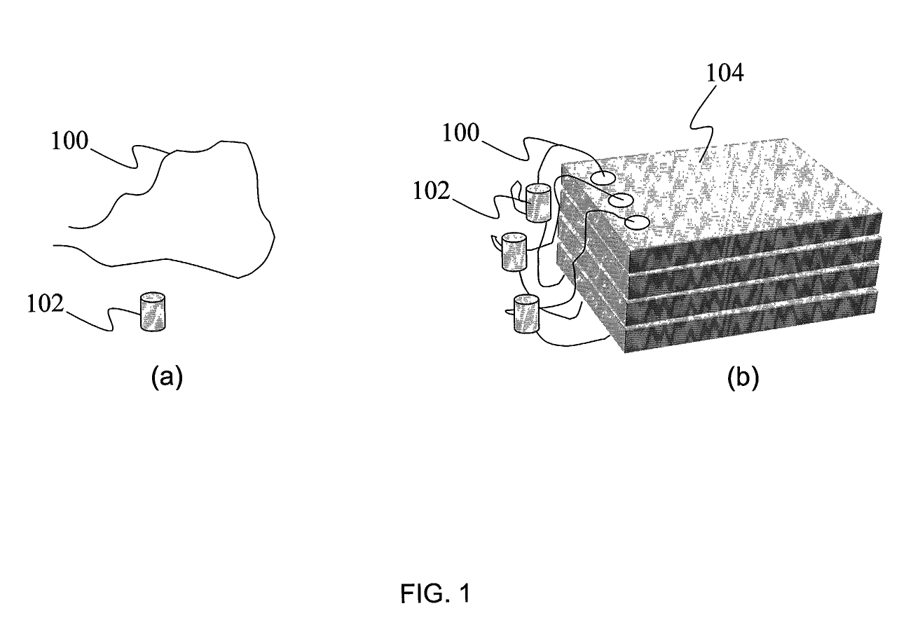

An illustration of a vinyl lace and bead used for binding a plurality of foam pages to create the bound foam book of the present invention is depicted in FIG. 1(a). The binding means shown comprises a vinyl lace 100 and a bead 102, and is depicted unattached to any pages for clarity. When used for bookbinding, the vinyl lace 100 is passed through a hole in a plurality of foam pages 104 and through a passage or hole in the bead 102, and is secured to bind the foam pages 104 as a book. A foam book using three vinyl lace 100 and bead 102 binding means is depicted in FIG. 1(b). The book may have any number of holes to be bound in accordance with the present invention.

All of the materials from which the book is fabricated, including the vinyl lace 100, the bead 102, and the foam pages 104 are designed to be waterproof and easy to clean. The book is designed principally for small children and is intended to be used in all environments, both dry and wet (such as in a bathtub or swimming pool). Additionally, it is intended that dirt, food, and other materials may be easily removed from the book. The lace is preferably vinyl, but may be of another suitable material which is easily cleanable. Thus, the term vinyl, as used herein, is intended to accommodate a variety of various typically tough and flexible plastics (commonly known as vinyl). Additionally, the bead 102 used may be shaped to be attractive for children. Non-limiting examples of bead designs include animals (such as cats, dogs, bears, etc.), cartoon characters, and vehicles. The bead may be made of any tough, preferably water-resistant or waterproof material. In addition to being shaped attractively for children, the bead 102 may also incorporate a noise-making mechanism such as a bell (not shown in the figures). Typically, the noise-making mechanism would be housed within the bead 102.

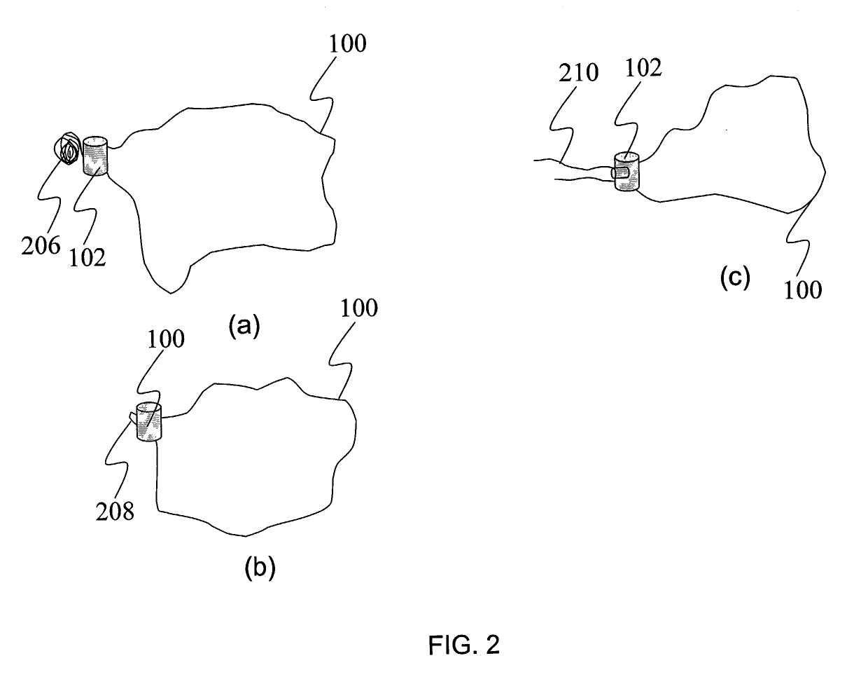

A variety of different mechanisms for securing the vinyl strip 100 to the bead 102 in order to hold the pages 104 are depicted in FIG. 2. First, an illustration of an embodiment depicted with the lace passed through the bead and knotted in a manner which would secure a plurality of foam pages is shown in FIG. 2(a). In order to secure the pages 104 (not shown), the vinyl strip 100 is passed through the pages 104 and the bead 102, and is tied in a knot 206 on the side of the bead 102 opposite the pages 104. The knot 206 may form a permanent means of attaching the bead 102 and the pages 104 on the vinyl strip 100, or it may also be untied so that the bead 102 and the pages 104 are detachably attached to the vinyl strip 100.

Next, an illustration of an embodiment depicted with the lace passed through the bead and permanently attached itself is shown in FIG. 2(b). In this case, to secure the pages 104 (not shown), the vinyl strip 100 is passed through the pages 104 and the bead 102, and is permanently affixed to itself in a loop 208 on the side of the bead 102 opposite the pages 104. The loop 208 forms a permanent means of attaching the bead 102 and the pages 104 on the vinyl strip 100. The loop 208 may be formed by melting, chemically attaching, or mechanically attaching the vinyl strip 100 to itself.

An illustration of an embodiment depicted with the lace passed through the bead and fixedly secured by a spring-loaded retention mechanism that can be used to adjust the length of the lace used for securing a plurality of foam pages is shown in FIG. 2(c). In this case, to secure the pages 104 (not shown), the vinyl strip 100 is passed through the pages 104 and the bead 102, and is held in place by a spring loaded mechanism incorporated into the bead 102. The spring loaded mechanism may include a button that, when depressed, releases the vinyl strip 100 such that the bead 102 may be removed or the length of the lace used for securing the foam pages 104 may be adjusted. Although a spring-loaded mechanism is depicted and is preferred, other retention mechanisms could be used. Note also that the ends of the vinyl strip 210 are depicted as unattached to each other but may be attached by any desired means.

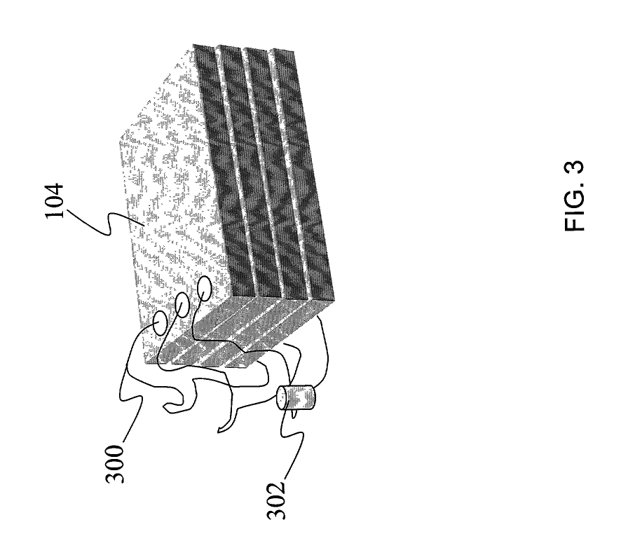

An alternate embodiment of the present invention, wherein a vinyl lace is threaded through a plurality of holes in a plurality of foam pages and secured by a single bead is shown in FIG. 3. In this case, a long vinyl strip 300 is passed through a plurality of holes in a plurality of pages 104, and is secured by a single bead 302. Any of the above bead types and securing mechanisms may be incorporated into this embodiment.

The present invention also encompasses a method for binding a foam-based book using a vinyl lace and bead binder. The first step in the method is that of providing at least one vinyl lace and bead binding including a vinyl strip and a bead having at least one hole. Next, a plurality of foam book pages perforated with at least one hole therethrough are provided. The pages are then retained with a vinyl lace and bead binding by passing the vinyl strip of the binding through the hole in the pages and the hole in the bead. Finally, the vinyl strip is connected such that the bead and the pages are held by the vinyl strip, whereby the pages may be held in a book-like fashion with the vinyl strip forming a loop-type binding. Thus, the book is completed.

In addition, in the step of connecting the vinyl strip 100, the vinyl strip 100 may be tied into a knot such that the bead 102 and the pages 104 are held by the vinyl strip 100. Further, in the step of connecting the vinyl strip 100, the step may comprise detachably attaching the vinyl strip 100 to the bead 102 in a detachably attachable manner. This may occur through the use of a bead with a spring-loaded mechanism that holds the vinyl strip 100 fixedly in place or it may occur through other mechanisms such as clips.

The step of connecting the vinyl strip 100 may also include the sub-step of sizably adjusting the length of the vinyl strip 100 via the bead 102 in order to accommodate a varying number of pages 104. Thus, the bead 102 may be slid along the vinyl strip 100 in order to adjust the length available for retaining pages 104.

In order to enhance it's attractiveness for children, the bead 102 may be shaped in the form of an animal or another object, non-limiting examples of which include vehicles and cartoon characters. Additionally, the bead 102 may include a noise-making device such as a bell or whistle to provide additional entertainment to children.

What is claimed is:

1. A vinyl lace and bead bound foam-based book comprising:
a. at least one vinyl lace and bead binding including a vinyl strip and a bead having at least one hole; and
b. a plurality of foam book pages perforated with at least one hole therethrough, with a vinyl lace and bead binding retaining the pages at each hole with the vinyl strip of the binding passed through the hole in the pages and the hole in the bead, with the vinyl strip connected with the bead such that the bead and the pages are held by the vinyl strip, whereby the pages may be held in a book-like fashion with the vinyl strip forming a loop-type binding.

2. A vinyl lace and bead bound foam-based book as set forth in claim 1, wherein the vinyl strip is connected with the bead by passing the vinyl strip through a hole in the bead and tying the vinyl strip such that the bead is retained thereon.

3. A vinyl lace and bead bound foam-based book as set forth in claim 1, wherein the vinyl strip is connected with the bead and a secondary securing vinyl strip by passing the vinyl strip through a hole in the secondary securing vinyl strip and is further passed through the bead and tying the vinyl strip such that the secondary securing vinyl strip and the bead is retained thereon.

4. A vinyl lace and bead bound foam-based book as set forth in claim 1, wherein the vinyl strip is connected with the bead by passing the vinyl strip through a hole in the bead and tying the vinyl strip such that the bead is retained thereon.

5. A vinyl lace and bead bound foam-based book as set forth in claim 4, wherein the vinyl and lace bead binding may be sizably adjusted to accommodate a variable number of pages.

6. A vinyl lace and bead bound foam-based book as set forth in claim 5, wherein the vinyl strip is connected with the bead by passing the vinyl strip through a hole in the bead and tying the vinyl strip such that the bead is retained thereon.

7. A vinyl lace and bead bound foam-based book as set forth in claim 6, wherein the bead is in the shape of an animal.

8. A vinyl lace and bead bound foam-based book as set forth in claim 6, wherein the bead includes a noise-making device.

9. A vinyl lace and bead bound foam-based book as set forth in claim 1, wherein the bead is in the shape of an animal.

10. A vinyl lace and bead bound foam-based book as set forth in claim 1, wherein the bead includes a noise-making device.

11. A vinyl lace and bead bound foam-based book as set forth in claim 1, wherein the vinyl and lace bead binding may be sizably adjusted to accommodate a variable number of pages.

12. A method for binding a foam-based book using a vinyl lace and bead binder, the method comprising the steps of:
a. providing at least one vinyl lace and bead binding including a vinyl strip and a bead having at least one hole;
b. providing a plurality of foam book pages perforated with at least one hole therethrough;
c. retaining the pages with a vinyl lace and bead binding by passing the vinyl strip of the binding through the hole in the pages and the hole in the bead; and
d. connecting the vinyl strip such that the bead and the pages are held by the vinyl strip, whereby the pages may be held in a book-like fashion with the vinyl strip forming a loop-type binding.

13. A method for binding a foam-based book using a vinyl lace and bead binder as set forth in claim 12, wherein the step of connecting the vinyl strip comprises tying the vinyl strip such that the bead and the pages are held by the vinyl strip.

14. A method for binding a foam-based book using a vinyl lace and bead binder as set forth in claim 12, wherein the step of connecting the vinyl strip comprises detachably attaching the vinyl strip to the bead such that the bead and the pages are held by the vinyl strip.

15. A method for binding a foam-based book using a vinyl and lace binder as set forth in claim 14, wherein the step of connecting the vinyl strip includes a sub-step of sizably adjusting the vinyl lace and bead binding to accommodate a varying number of pages.

16. A method for binding a foam-based book using a vinyl lace and bead binder as set forth in claim 15, wherein in the step of connecting the vinyl strip to the bead by tying the vinyl strip.

17. A method for binding a foam-based book using a vinyl lace and bead binder as set forth in claim 15, wherein prior to the step of connecting the vinyl strip to the bead, the vinyl strip is further passed through a second securing vinyl strip and is then secured to the bead by tying the vinyl strip.

18. A method for binding a foam-based book using a vinyl lace and bead binder as set forth in claim 12, wherein the bead provided is in the shape of an animal.

19. A method for binding a foam-based book using a vinyl lace and bead binder as set forth in claim 12, wherein the bead includes a noise making device.

20. A method for retaining the pages with a vinyl lace and bead binding by passing the vinyl strip of the binding through the hole in the pages and the hole in the bead as set forth in claim 12, wherein the vinyl lace strip is further passed through a second securing vinyl strip followed by the securing bead.
